(19) United States
(12) Patent Application Publication
(10) Pub. No.: US 2017/0341214 A1
(43) Pub. Date: Nov. 30, 2017

(54) HAND-HELD POWER TOOL GEARBOX CLOSURE AND HAND-HELD POWER TOOL

(71) Applicant: Hilti Aktiengesellschaft, Schaan (LI)

(72) Inventor: Oliver Ohlendorf, Landsberg am Lech (DE)

(21) Appl. No.: 15/527,262

(22) PCT Filed: Nov. 20, 2015
(86) PCT No.: PCT/EP2015/077204

§ 371 Date: May 16, 2017

(30) Foreign Application Priority Data
Nov. 21, 2014 (EP) 14194231.8

(51) Int. Cl. B25F 5/02; B25D 9/00

(52) U.S. Cl. CPC B25F 5/02; B25D 9/00; B25D 2250/185

(57) ABSTRACT

A hand-held tool transmission closure having a base body for closing a transmission housing opening of a transmission housing of a hand-held power tool, in particular a hammer drill or a combi-hammer, wherein the hand-held power tool transmission closure includes an air channel, through which air is able to flow into and out of the transmission housing, and wherein the hand-held power tool transmission closure includes a pressure valve arranged in the air channel, via which an excess pressure occurring in the transmission housing can be reduced.

The present invention relates to a hand-held power tool gearbox closure including a base body for closing a gearbox housing opening of a gearbox housing of a hand-held power tool, in particular of a hammer drill or a combi-hammer. The present invention also relates to a hand-held power tool including a hand-held power tool gearbox closure.

### BACKGROUND

A striking mechanism including a piston, a connecting rod and a snap-die may be situated inside the gearbox housing of a typical hand-held power tool. These are lubricated by a lubricant, such as a gearbox oil, present in the gearbox housing in order to work together in a preferably low-friction manner. The lubricant is typically introduced into the gearbox housing via the gearbox housing opening. To prevent the lubricant from exiting the gearbox housing, the gearbox housing opening is closed by a base body of a hand-held power tool gearbox closure. The base body may be designed as a plug.

### SUMMARY OF THE INVENTION

It is an object of the present invention to provide an improved hand-held power tool gearbox closure which favors an increased service life of a hand-held power tool. It is also the object of the present invention to provide a hand-held power tool including a thus improved hand-held power tool gearbox closure.

With respect to the hand-held power tool gearbox closure, the object is achieved in that the hand-held power tool gearbox closure includes an air channel through which air is able to flow into and out of the gearbox channel, and the hand-held power tool gearbox closure includes a pressure valve situated in the air channel, via which an overpressure occurring in the gearbox housing may be relieved. Preferably, an underpressure occurring in the gearbox housing may be compensated via the pressure valve.

Air, which due to the power tool operation, and specifically due to heating of the lubricant present in the gearbox housing, may now advantageously escape from the gearbox housing.

The present invention includes the finding that, due to the closed design of a gearbox housing and its closing with the aid of a base body having no air channel, the internal pressure of a gearbox housing rises to an undesirably high pressure level during the operation of the power tool. A high pressure level is disadvantageous for the service life, and in particular also for the operating performance data, for example the delivered striking energy of the hand-held power tool. The hand-held power tool closure according to the present invention helps to eliminate these disadvantages in that a gearbox internal pressure is regulatable.

In one preferred embodiment, the pressure valve is situated inside the hand-held power tool gearbox closure and may be designed as an elastic hose element. A relief of an overpressure occurring in the gearbox housing is preferably accompanied by an elastic deformation of the elastic hose element. The pressure valve designed as an elastic hose element may be installed into the hand-held power tool gearbox closure in a pretensioned state. Advantageously, the pressure valve designed as an elastic hose element is made of silicone.

The pressure valve may be designed in such a way that it does not open until a predetermined pressure difference, for example 2 bar, between the ambient pressure and the gearbox pressure is exceeded. This is advantageous, for example, when the power tool includes an electropneumatic striking mechanism for which a setpoint overpressure is desirable.

It has proven advantageous that the hand-held power tool gearbox closure have a cover part including ventilation openings. The cover part preferably projects into the base body, the pressure valve designed as an elastic hose element in particular being supported both against the base body and against the cover.

In one particularly preferred embodiment, the hand-held power tool gearbox closure includes an air-permeable, and in particular essentially gearbox oil-tight, sealing element. The sealing element is preferably situated in the air channel. The inventor recognized in this regard that a lubricant, in particular oil, must not leak from a gearbox housing since otherwise the lubricating performance decreases on the one hand, and the surface of the power tool visible to the user becomes soiled on the other hand. An air-permeable and gearbox oil-tight sealing element ensures pressure equalization on the one hand, and prevents oil from exiting the gearbox housing on the other hand.

It has proven to be advantageous that the sealing element be made up of felt or at least include felt. The sealing element may be made of up a dense textile fibrous material. It has furthermore proven to be advantageous that the sealing element be situated beneath the pressure valve at least in sections when the hand-held power tool gearbox closure is in its intended installation situation.

The base body and/or the cover part preferably has a rotation-symmetrical design. In this way, cost-effective production on a lathe is possible. In order to enable a uniformly distributed flow of air through the ventilation openings, the ventilation openings are preferably annularly situated on a surface of the cover part.

In one further preferred embodiment, the base body includes a trough-shaped section, which is preferably situated opposite the cover part, and further preferably projects into the gearbox housing, when the base body closes the gearbox housing opening. The trough-shaped section of the base body may include an opening borehole, via which an air volume may enter or exit the air channel. The trough-shaped section of the base body may have a rotation-symmetrical design. The opening borehole is preferably designed as a through-hole along a secant of the rotation-symmetrically designed trough-shaped section of the base body.

In one preferred embodiment, the base body includes a sealing ring, which is situated to seal the base body circumferentially with respect to the gearbox housing opening. The base body is preferably designed as a plug. A plug function of the base body may be effectuated, for example, by a sealing ring provided on the base body. As an alternative or in addition, the base body may include lamellae, which are designed to hold the base body in a gearbox housing opening in a force-fit manner.

With respect to the hand-held power tool, the object is achieved in that the hand-held power tool includes an above-described hand-held power tool gearbox closure.

### BRIEF DESCRIPTION OF THE DRAWINGS

Further advantages are derived from the following description of the drawings. The drawings show one exemplary embodiment of the present invention, and the drawing, the description and the claims include numerous features and combinations. Those skilled in the art will advantageously also consider the features individually and combine them into useful further combinations.

FIGS. 1a, 1b and 1c show a schematic illustration of a hand-held power tool gearbox closure according to the present invention;

FIG. 2 shows a schematic illustration of the hand-held power tool gearbox closure when the gearbox internal pressure and the ambient pressure are essentially the same;

FIG. 3 shows a schematic illustration of the hand-held power tool gearbox closure from FIG. 2 when the gearbox internal pressure is greater than the gearbox ambient pressure;

FIG. 4 shows a schematic perspective illustration of a hand-held power tool gearbox closure according to the present invention; and

FIG. 5 shows a hand-held power tool including a hand-held power tool gearbox closure.

### DETAILED DESCRIPTION

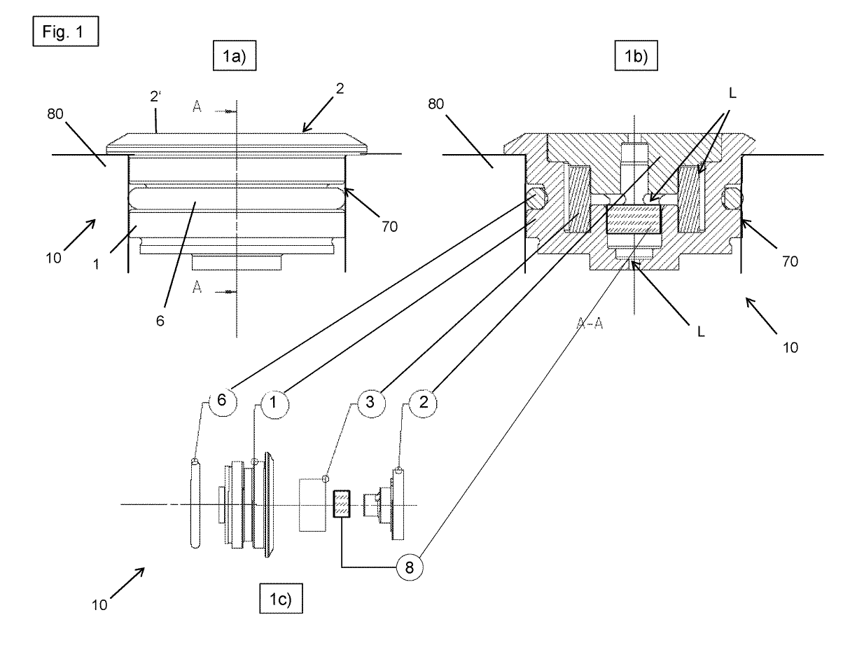

FIG. 1a, FIG. 1b and FIG. 1c illustrate a hand-held power tool gearbox closure 10 according to the present invention in various views. FIG. 1a schematically shows a side view of the rotation-symmetrically designed hand-held power tool gearbox closure 10 including a plotted intersecting line A-A. FIG. 1b shows the section A-A through the hand-held power tool gearbox closure 10 corresponding to intersecting line A-A from FIG. 1a. FIG. 1c, in turn, shows an exploded view of hand-held power tool gearbox closure 10.

Hand-held power tool gearbox closure 10 in FIG. 1 includes a base body 1 for closing a gearbox housing opening 70 of a gearbox housing 80. Hand-held power tool gearbox closure 10 furthermore includes an air channel L through which an air mass (not shown) is able to flow into and out of the gearbox housing for the purpose of pressure equalization. Furthermore, a pressure valve 3, via which an overpressure or underpressure present in gearbox housing 80 may be relieved, is situated in air channel L of hand-held power tool gearbox closure 10.

In the present example, pressure valve 3 is situated inside hand-held power tool gearbox closure 10 and designed as an elastic hose element made of silicone. Pressure valve 3 designed as an elastic hose element is situated coaxially with respect to rotation-symmetrically designed base body 1 of hand-held power tool gearbox closure 10.

Furthermore, hand-held power tool gearbox closure 10 has a cover part 2, which includes a ventilation opening 2′ on its surface. Ventilation opening 2′ is not apparent in the sectional illustration of FIG. 1b; it is described with respect to the further figures. Cover part 2, which also has a rotation-symmetrical design, projects into base body 1.

As is apparent from FIG. 1b), pressure valve 3 designed as an elastic hose element is supported both against base body 1 and against cover part 2 and installed into hand-held power tool gearbox closure 10 in a pretensioned state.

A sealing element 8, which in the present example is made of felt and has a rotation-symmetrical design, is situated coaxially with respect to pressure valve 3. Air-permeable and essentially gearbox oil-tight sealing element 8 is situated on its bottom side flush with pressure valve 3. Air-permeable and gearbox oil-tight sealing element 8 ensures pressure equalization on the one hand, and prevents oil from exiting gearbox housing 80, for example in the form of oil vapor, on the other hand.

Hand-held power tool gearbox closure 10 includes a sealing ring 6, which is situated to seal base body 1 circumferentially with respect to shown gearbox housing opening 70.

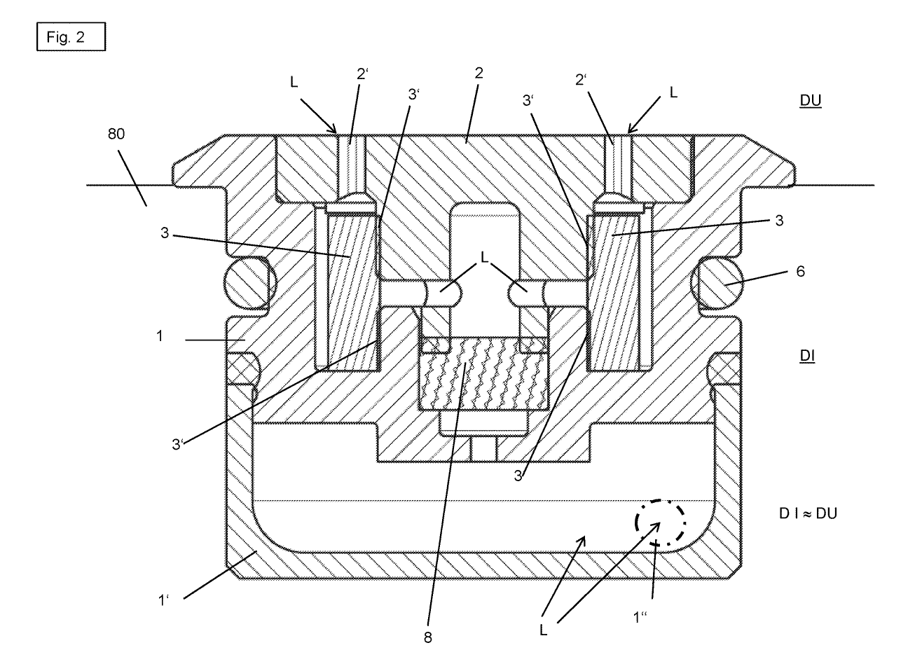

FIG. 2 shows hand-held power tool gearbox closure 10 in the state which pressure valve 3 assumes when gearbox internal pressure DI and ambient pressure DU are essentially identical. This is the case, for example, when the hand-held power tool has not been operated in some time, or during operation of the hand-held power tool when a pressure equalization has already taken place.

Base body 1 includes a trough-shaped section 1′ in which an opening borehole 1″ is situated. This opening borehole 1″ similarly forms an inlet for air channel L of the hand-held power tool gearbox closure, air channel L extending through hand-held power tool gearbox closure 10 up to ventilation opening 2′ in cover part 2.

Pressure valve 3, which is installed into hand-held power tool gearbox closure 10 in a pretensioned manner and designed as an elastic hose element, is pressed against a valve seat 3′, which forms part of cover part 2 as well as part of base body 1.

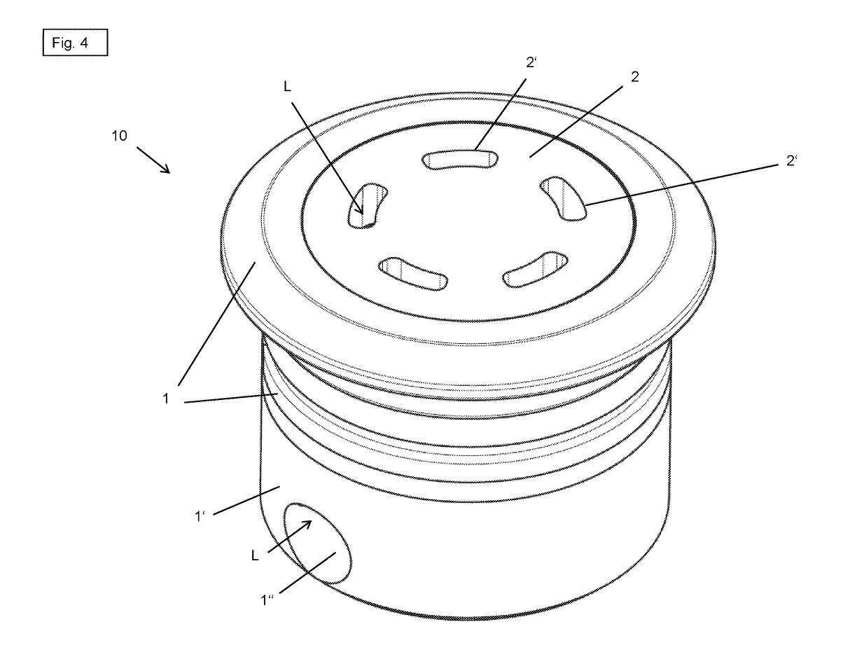

Based on the sectional illustration of hand-held power tool gearbox closure 10 selected in FIG. 2, two of ventilation openings 2′ of cover part 2 are apparent. Remaining ventilation openings 2′, which are situated annularly on the surface of the cover part, are apparent from FIG. 4, for example.

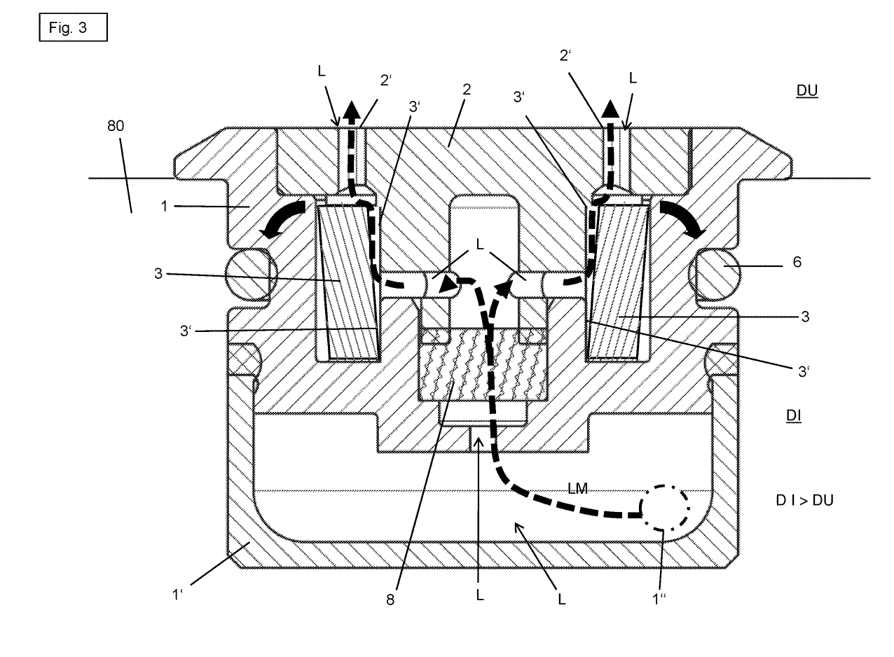

FIG. 3 now shows the same hand-held power tool gearbox closure 10 as FIG. 2, FIG. 3 showing the state which pressure valve 3 assumes when gearbox internal pressure DI exceeds ambient pressure DU, i.e., when an overpressure is present in gearbox housing 80. This is the case, for example, when the striking mechanism (not shown) has heated a lubricant present in gearbox housing 80. In the present example, pressure valve 3 is designed in such a way that it does not open until a predetermined pressure difference of 2 bar between ambient pressure DU and gearbox internal pressure DI is exceeded in order to reach a setpoint overpressure in gearbox housing 80, i.e., pressure valve 3 does not open until gearbox internal pressure DI exceeds ambient pressure DU by 2 bar.

Hereafter, air channel L, which extends through hand-held power tool gearbox closure 10, is described in greater detail with reference to FIG. 3. Starting in opening borehole 1″, air channel L extends through trough-shaped section 1′ of base body 1 in the direction of centrally situated sealing element 8. From there, air channel L branches into an annular channel section leading to pressure valve 3. According to the present invention, pressure valve 3 is situated inside air channel L of hand-held power tool gearbox closure 10. Ventilation openings 2′ of cover part 2 abut pressure valve 3 and, in turn, form sections of air channel L of hand-held power tool gearbox closure 10. Air channel L ends with ventilation openings 2′ of cover part 2.

FIG. 3 furthermore, by way of example, shows an air mass LM with the aid of a dotted line, which due to gearbox internal pressure DI, which is greater than ambient pressure DU, moves in the direction of arrow through air channel L of hand-held power tool gearbox closure 10 out of gearbox housing 80. Air mass LM initially passes opening borehole 1″ to travel thereafter through air-tight and essentially gearbox oil-tight sealing element 8. Lubricants or oil residue previously present in air mass LM are retained by sealing element 8 and are thereafter not able to exit the hand-held power tool gearbox closure 10.

As is also apparent from FIG. 3, air mass LM moves in the direction of pressure valve 3 designed as an elastic hose element, this pressure valve—it is installed in a pretensioned state—being pushed toward the outer side of base body 1, undergoing further elastic deformation, i.e., as shown in FIG. 3 lifting off the portion of valve seat 3′ surrounded by cover part 2. Corresponding to the direction of arrow of the dotted line, air mass LM is thereafter able to escape from hand-held power tool gearbox closure 10 through ventilation openings 2′ of cover part 2. After the pressure equalization has taken place, pressure valve 3 returns to its starting position shown in FIG. 2.

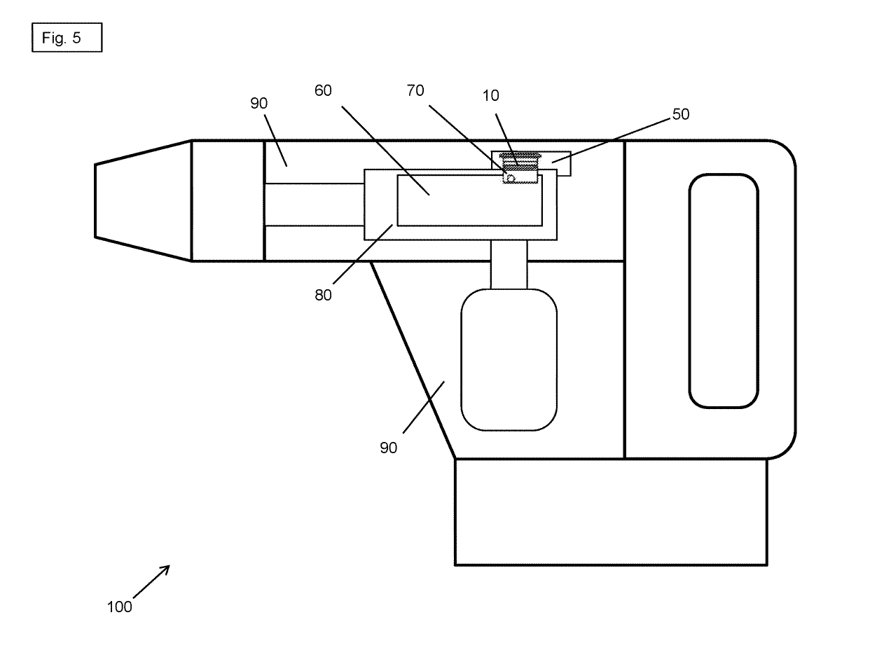

FIG. 4 shows hand-held power tool gearbox closure 10 in a schematic and perspective illustration. The rotation-symmetrical design of base body 1 including its trough-shaped section 1′ is easily apparent, as is the rotation-symmetrical design of cover part 2, on whose surface five ventilation openings 2′ are annularly situated. On the side of trough-shaped section 1′ of base body 1 facing a striking mechanism 60 (see FIG. 5) in the installed state, opening borehole 1″ is situated, through which an air mass LM is able to enter (in the case of overpressure relief) or exit (in the case of underpressure equalization) air channel L of hand-held power tool gearbox closure 10.

A hand-held power tool 100 according to the present invention including a hand-held power tool gearbox closure 10 is shown in FIG. 5. Hand-held power tool 100 includes a housing 90, which encloses a gearbox housing 80. A striking mechanism 60, which develops heat in the course of the operation of hand-held power tool 100, is situated within gearbox housing 80. A gearbox housing opening 70, which in the present example is closed by a hand-held power tool gearbox closure 10, is situated on the upper side of gearbox housing 80. Hand-held power tool gearbox closure 10 is covered by an oscillating plate 50.

### LIST OF REFERENCE NUMERALS

DI gearbox internal pressure
DU ambient pressure
L air channel
LM air mass
1 base body
1′ trough-shaped section
1″ opening borehole
2 cover part
2′ ventilation opening
3 pressure valve
3′ valve seat
6 sealing ring
8 sealing element
10 hand-held power tool gearbox closure
50 oscillating plate
60 striking mechanism
70 gearbox housing opening
80 gearbox housing
90 power tool housing
100 hand-held power tool

1-10. (canceled)

11. A hand-held power tool gearbox closure comprising:
a base body for closing a gearbox housing opening of a gearbox housing of a hand-held power tool;
an air channel, an air mass capable of flowing into and out of the gearbox housing through the air channel; and
a pressure valve situated in the air channel, and via which an overpressure occurring in the gearbox housing being relievable via the pressure valve.

12. The hand-held power tool gearbox closure as recited in claim 1 wherein the pressure valve is situated inside the hand-held power tool gearbox closure and designed as an elastic hose element, a relief of an overpressure occurring in the gearbox housing being accompanied by an elastic deformation of the hose element.

13. The hand-held power tool gearbox closure as recited in claim 12 wherein the pressure valve designed as the elastic hose element is installed in a pretensioned state.

14. The hand-held power tool gearbox closure as recited in claim 12 further comprising a cover part including ventilation openings, the cover part projecting into the base body, the pressure valve designed as the elastic hose element being supported both against the base body and against the cover part.

15. The hand-held power tool gearbox closure as recited in claim 11 wherein an underpressure occurring in the gearbox housing is equalizable with the aid of the pressure valve.

16. The hand-held power tool gearbox closure as recited in claim 11 further comprising an air-permeable and gearbox oil-tight seal situated in the air channel.

17. The hand-held power tool gearbox closure as recited in claim 16 wherein the seal is situated coaxially with respect to the pressure valve.

18. The hand-held power tool gearbox closure as recited in claim 16 wherein the seal is made of felt or at least includes felt.

19. The hand-held power tool gearbox closure as recited in claim 11 wherein the base body includes a sealing ring situated to seal the base body circumferentially with respect to the gearbox housing opening.

20. The hand-held power tool gearbox closure as recited in claim 11 wherein the base body is designed as a plug.

21. A hand-held power tool comprising:
a gearbox housing enclosed by a power tool housing and accessible via a gearbox housing opening; and
the hand-held power tool gearbox closure as recited in claim 10.

22. A hammer drill or a combi-hammer comprising the hand-held power tool as recited in claim 21.
